(19) United States
(12) Patent Application Publication
(10) Pub. No.: US 2026/0290367 A1
(43) Pub. Date: Sep. 24, 2026

(54) AUDIO DE-REVERBERATION

(71) Applicant: DOLBY LABORATORIES LICENSING CORPORATION

(72) Inventors: Jia Dai, Beijing (CN); Kai Li, Beijing (CN)

(73) Assignee: DOLBY LABORATORIES LICENSING CORPORATION, (US)

(21) Appl. No.: 18/874,309

(22) PCT Filed: Jun. 27, 2023
(86) PCT No.: PCT/US2023/069195

§ 371 Date: Dec. 12, 2024

Related U.S. Application Data
(60) Provisional application No. 63/434,093, filed on Dec. 21, 2022.
(60) Provisional application No. 63/490,063, filed on Mar. 14, 2023.

(30) Foreign Application Priority Data
Jun. 30, 2022 (WO) PCT/CN2022/102984

(51) Int. Cl. G10L 21/0208; G06N 20/00

(52) U.S. Cl. CPC G10L 21/0208; G06N 20/00; G10L 2021/02082

(57) ABSTRACT

Method and system for generating a set of synthesized AIRs from a real acoustic impulse response, AIR(t), and using the set of synthesized AIRs to train a machine learning model, such that the machine learning model, after training, is configured to generate a de-reverberated audio signal given an input audio signal. The synthesized AIRs are generated by forming an early portion, AIRₑ(t) and a late portion, AIRₗ(t) of the real AIR by selecting a random separation time point, s, and a random crossfade duration, d. With the proposed approach, a “soft” separation of the real AIR into an early AIR and a late AIR. Specifically, the early AIR will decay to zero during a transition period d, while the late AIR will gradually increase from zero during the transition period. The sum of the early AIR and late AIR will still be equal to the real AIR.

### CROSS-REFERENCE TO RELATED APPLICATIONS

This application claims priority to International Application No. PCT/CN2022/102984, filed Jun. 30, 2022, U.S. Provisional Application No. 63/434,093 filed on Dec. 21, 2022 and U.S. Provisional Application No. 63/490,063 filed on Mar. 14, 2023, each of which is hereby incorporated by reference in its entirety.

### TECHNICAL FIELD OF THE INVENTION

The present invention relates to the dereverberation of audio signals.

### BACKGROUND OF THE INVENTION

With audio recording devices being readily available in many contexts, audio content is being generated in a variety of different situations, and with different quality. Audio content such as podcasts, radio shows, television shows, music videos, user-generated content, short-video, video meetings, teleconferencing meetings, panel discussions, interviews, etc., may include various types of distortion, including reverberation.

Reverberation occurs when an audio signal is distorted by reflections off of various surfaces (e.g., walls, ceilings, floors, furniture, etc.) before it is picked up by the receiver. Reverberation may have a substantial impact on sound quality and speech intelligibility. More specifically, sound arriving at a receiver (e.g., a human listener, a microphone, etc.) is made up of direct sound, which includes sound directly from the source without any reflections, and reverberant sound, which includes sound reflected off of various surfaces in the environment. The reverberant sound includes early reflections and late reflections. Early reflections may reach the receiver soon after or concurrently with the direct sound, and may therefore be partially integrated into the direct sound. The integration of early reflections with direct sound creates a spectral coloration effect which contributes to a perceived sound quality. The late reflections arrive at the receiver after the early reflections (e.g., more than 50-80 milliseconds after the direct sound). The late reflections may have a detrimental effect on speech intelligibility. Accordingly, dereverberation may be performed on an audio signal to reduce an effect of late reflections present in the audio signal to thereby improve speech intelligibility and clarity.

The de-reverberation of audio signals is an area where machine learning has been found highly useful. For example, machine learning models, such as deep neural networks, may be used to predict a dereverberation mask that generates a de-reverberated audio signal when applied to a reverberant audio signal.

A machine learning model for de-reverberating audio signals may be trained using a training set including a suitable number of training samples, where each training sample includes a clean audio signal (e.g., with no reverberation), and a corresponding reverberated audio signal. In order for a machine learning model to be robust, the training set may need to capture reverberation from a vast number of different room types (e.g., rooms having different sizes, layouts, furniture, etc.), a vast number of different speakers, etc.

A training set may be generated by obtaining various acoustic impulse responses (AIRs) that each characterize a room reverberation. A training sample can then be formed by a clean audio signal and a corresponding reverberated audio signal generated by convolving an AIR with the clean audio signal. However, there may be a limited number of real AIRs available, and the real AIRs that are available may not fully characterize potential reverberation effects (e.g., by not adequately capturing rooms of different dimensions, layouts, etc.).

Document WO 2023/287782 discloses techniques for generating an augmented training set that may be used to train a robust machine learning model for de-reverberating audio signals. In WO 2023/287782, real AIRs (measured or modeled) are used to generate a set of synthesized AIRs. The synthesized AIRs may be generated by altering and/or modifying various characteristics of early reflections and/or late reflections of a real AIR.

### GENERAL DISCLOSURE OF THE INVENTION

Although the methods disclosed in WO 2023/287782 have been found very useful, it would be beneficial to even further improve the process of synthesizing AIRs.

It is an object of the present invention to further improve the process of AIR synthesis, to enable generation of augmented training data for a de-reverberation machine learning model.

According to a first aspect of the invention, this and other objects are achieved by a method for training a machine learning model, the method comprising generating a set of synthesized AIRs from a real acoustic impulse response, AIR(t), using the set of synthesized AIRs to generate a plurality of training samples, each training sample comprising a non-reverberated audio signal and a reverberated audio signal formed by applying one of the synthesized AIRs to the non-reverberated audio signal, and training the machine learning model with the plurality of training samples, such that the machine learning model, after training, is configured to generate a de-reverberated audio signal given an input audio signal.

The synthesized AIRs are generated by forming an early portion, AIRₑ(t), of the real AIR corresponding to early reflections of a direct sound, and a late portion, AIRₗ(t), of the real AIR corresponding to late reflection of a direct sound, and generating each synthesized AIR by modifying at least one of the early portion and the late portion and recombining the possibly modified early portion and possibly modified the late portion.

The early portion and late portion are formed by selecting a random separation time point, s, selecting a random crossfade duration, d, defining a transition function of time ƒ(t) which describes a continuous decrease from one to zero as t increases from s to s+d, defining an early crossfade function as:

$${f}_{e} ( t ) = \{ \begin{matrix}1 & t < s \\ f ( t ) & s \leq t \leq t + d \\ 0 & t > s + d\end{matrix}$$

defining a late crossfade function as:

$${f}_{l} ( t ) = 1 - {f}_{e} ( t ) ,$$

calculating the early portion, AIRₑ(t), and the late portion, AIRₗ(t), as:

$${AIR}_{e} ( t ) = AIR ( t ) * {f}_{e} ( t ) and {AIR}_{l} ( t ) = AIR ( t ) * {f}_{1} ( t ) , respectively .$$

With the proposed approach, a “soft” separation of the real AIR into an early AIR and a late AIR. Specifically, the early AIR will decay to zero during a transition period d, while the late AIR will gradually increase from zero during the transition period. The sum of the early AIR and late AIR will still be equal to the real AIR.

With such a “soft” transition, discontinuities in the early and late AIRs are avoided, improving the training. Further, the transition period introduces yet another variable which may contribute to diversity. For one single separation time point, there can be several different transition periods.

With this approach, the diversity of synthesized AIR patterns for deep-learning-based speech enhancement algorithms can thus be increased, hence improving the performance of the trained model.

The augmented AIR training data may improve the robustness of the deep noise suppression models under reverberant conditions and improve the de-reverb performance for deep speech dereverberation models. It can also be used to improve the robustness of speech/audio processing such as echo reduction under adverse reverberant conditions of real use cases.

In some embodiments, the modification of the late portion is done by applying a randomized attenuation function, g (t), to the late portion. By using a randomized decay function, diversity is increased even further. For a given separation point and a given transition period, there can be several different modified late portions, by using different randomized decay functions.

According to a second aspect of the invention, this and other objects are achieved by a computer implemented system for training a machine learning model, the system comprising a computer implemented process for generating a set of synthesized AIRs from a real acoustic impulse response, AIR(t), a computer implemented process for generating a plurality of training samples, each training sample comprising a non-reverberated audio signal and a reverberated audio signal formed by applying one of the synthesized AIRs to the non-reverberated audio signal, and a computer implemented training process for training the machine learning model using a training set including a plurality of training samples, each training sample comprising a non-reverberated signal and a reverberated signal formed by applying one of the synthesized AIRs to the non-reverberated audio signal.

The computer implemented process for generating a set of synthesized AIRs includes a separation block configured to receive a real acoustic impulse response, AIR(t), and to form an early portion, AIRₑ(t), of the real AIR corresponding to early reflections of a direct sound, and a late portion, AIRₗ(t), of the real AIR corresponding to late reflection of a direct sound, at least one processing block for modifying at least one of the early portion and the late portion, and a combination block for recombining the possibly modified early portion and the possibly modified late portion to form a synthesized AIR.

The separation block is configured to select a random separation time point, s, select a random crossfade duration, d, define a transition function of time ƒ(t) which describes a continuous decrease from one to zero as t increases from s to s+d, define an early crossfade function as:

$${f}_{e} ( t ) = \{ \begin{matrix}1 & t < s \\ f ( t ) & s \leq t \leq t + d \\ 0 & t > s + d\end{matrix}$$

define a late crossfade function as:

$${f}_{l} ( t ) = 1 - {f}_{e} ( t ) ,$$

calculate the early portion, AIRₑ(t), and the late portion, AIRₗ(t), as:

$${AIR}_{e} ( t ) = AIR ( t ) * {f}_{e} ( t ) and {AIR}_{l} ( t ) = AIR ( t ) * {f}_{l} ( t ) , respectively$$

### BRIEF DESCRIPTION OF THE DRAWINGS

Aspects of the present invention will be described in more detail with reference to the appended drawings, showing currently preferred embodiments of the invention.

FIG. 1 shows an audio signal with reverberations.

FIG. 2 shows a dereverberation system according to an implementation of the present invention.

FIG. 3 shows a process for training the machine learning model in FIG. 2.

FIG. 4 shows an example of a measured acoustic impulse response (AIR).

FIG. 5 shows schematically a process for generating synthesized AIRs from a real AIR according to an implementation of the present invention.

FIG. 6 shows an example of early and late crossover functions used to separate a real AIR into an early portion and a late portion.

FIG. 7A shows conventional separation of an AIR into an early portion and a late portion.

FIG. 7B shows separation of an AIR into an early portion and a late portion using the crossover functions in FIG. 5.

FIG. 8A shows an original (non-truncated) late portion.

FIG. 8B-D show the late portion in FIG. 8A truncated by an exponential decay function with different exponents.

FIG. 9 shows a process for generating a set of training samples according to an implementation of the present invention.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

In the following description, focus has been placed on how to obtain a training set. Other parts of the process, such as how to train a machine learning model, and how to use the trained machine learning model, are only briefly discussed. More details can be found in PCT Patent Publication No. WO 2023/287773, titled “SPEECH ENHANCEMENT”, hereby incorporated by reference.

As discussed briefly above, sound arriving at a receiver (human listener, microphone, etc.) is made up of direct sound (coming directly from the source, without any reflection), and reverberant sound. The total energy of the reverberant sound can be decomposed into two parts: early and late reflections. The early reflections reach the receiver quite shortly after the direct sound and are partially integrated into it, creating a spectral coloration effect on the speech. The late reflections, consisting of all the reflections arriving after the early ones, mainly have a detrimental effect on the perception of speech. As an example, late reflections may be considered to arrive 50-80 ms after the direct sound.

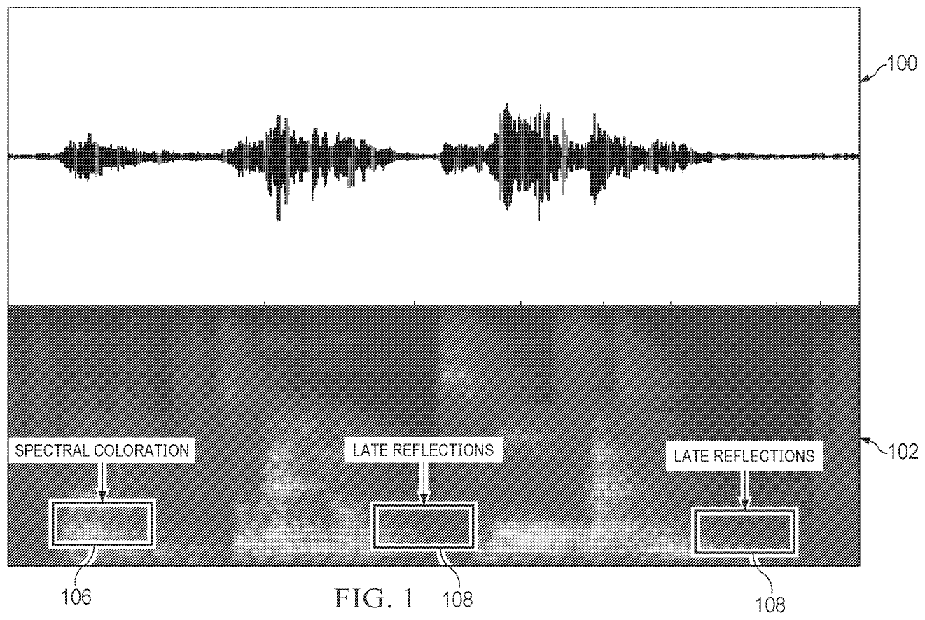

FIG. 1 shows an example of a time domain input audio signal 100 and a corresponding spectrogram 102. As illustrated in spectrogram 102, early reflections may produce changes in spectrogram as depicted by spectral colorations 106. Spectrogram 102 also illustrates late reflections 108, which may have a detrimental effect on speech intelligibility.

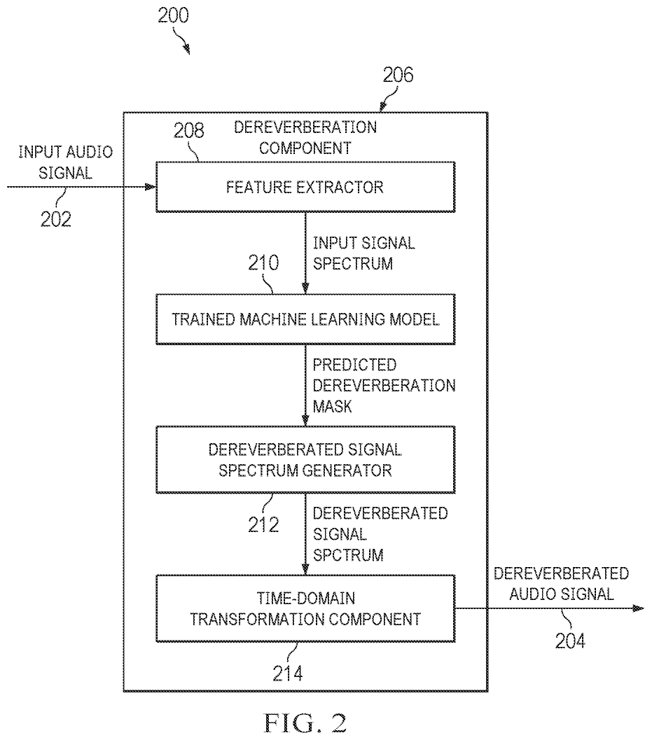

Machine learning models, such as deep neural networks, may be used to predict a dereverberation mask that, when applied to a reverberated audio signal, generates a dereverberated audio signal. FIG. 2 shows an example of a dereverberation system 200 for dereverberation of an audio signal 202. It is noted that the systems in FIG. 2 may be applied also to other types of signal enhancement, such as noise suppression, a combination of noise suppression and dereverberation, or the like. In other words, rather than generating a predicted dereverberation mask and a predicted dereverberated audio signal, in some implementations, a predicted enhancement mask may be generated, and the predicted enhancement mask may be used to generate a predicted enhanced audio signal, where the predicted enhanced audio signal is a denoised and/or dereverberated version of a distorted input audio signal.

In some implementations, the components of system 200 may be implemented by a user device, such as a mobile phone, a tablet computer, a laptop computer, a wearable computer (e.g., a smart watch, etc.), a desktop computer, a gaming console, a smart television, or the like.

The dereverberation system 200 in FIG. 2 takes, as an input, an input audio signal 202, and generates, as an output, a dereverberated audio signal 204. The input audio signal 202 may be a live-captured audio signal, such as live-streamed content, an audio signal corresponding to an in-progress video conference or audio conference, or the like. In some implementations, the input audio signal may be a pre-recorded audio signal, such as an audio signal associated with pre-recorded audio content (e.g., television content, a video, a movie, a podcast, or the like). In some implementations, the input audio signal may be received by a microphone of the user device. In some implementations, the input audio signal may be transmitted to the user device, such as from a server device, another user device, or the like.

In the illustrated implementation, the system 200 includes a feature extractor 208 for generating a frequency-domain representation of input audio signal 202, which may be considered an input signal spectrum. The frequency-domain representation of the input audio signal may be generated using a transform, such as a short-time Fourier transform (STFT), a modified discrete cosine transform (MDCT), or the like. In some implementations, the frequency-domain representation of the input audio signal is referred to herein as “binned features” of the input audio signal. In some implementations, the frequency-domain representation of the input audio signal may be modified by applying a perceptually-based transformation that mimics filtering of the human cochlea. Examples of perceptually-based transformations include a Gammatone filter, an equivalent rectangular bandwidth filter, a Mel-scale filter, or the like. The modified frequency-domain transformation is sometimes referred to herein as “banded features” of the input audio signal.

The input signal spectrum is then be provided to a trained machine learning model 210. The machine learning model is trained to generate a dereverberation mask that, when applied to the frequency-domain representation of the input audio signal, generates a frequency-domain representation of a dereverberated audio signal. In some implementations, the logarithm of the extracted features may be provided to the trained machine learning model.

The machine learning model 210 may have any suitable architecture or topology. For example, in some implementations, the machine learning model may be or may include a deep neural network, a convolutional neural network (CNN), a long short-term memory (LSTM) network, a recurrent neural network (RNN), or the like. In some implementations, the machine learning model may combine two or more types of networks. For example, in some implementations, the machine learning model may combine a CNN with a recurrent element. Examples of recurrent elements that may be used include a GRU, an LSTM network, an Elman RNN, or the like.

The predicted dereverberation mask generated by the trained machine learning model 210 is provided to a dereverberated signal spectrum generator 212. In some implementations, the predicted dereverberation mask is modified by applying an inverse perceptually-based transformation, such as an inverse Gammatone filter, an inverse equivalent rectangular bandwidth filter, or the like.

Dereverberated signal spectrum generator 212 applies the predicted dereverberation mask to the input signal spectrum to generate a dereverberated signal spectrum (e.g., a frequency-domain representation of the dereverberated audio signal). in some implementations, the predicted dereverberation mask is multiplied with the frequency-domain representation of the input audio signal. In instances in which the logarithm of the frequency-domain representation of the input audio signal was provided to the trained machine learning model, the logarithm of the predicted reverberation mask is subtracted from the logarithm of the frequency-domain representation of the input audio signal, and the difference is exponentiated to obtain the frequency-domain representation of the dereverberated audio signal.

The dereverberated signal spectrum is finally provided to a time-domain transformation component 214, which generates the dereverberated audio signal 204. For example, the time-domain representation of the dereverberated audio signal can be generated by applying an inverse transform (e.g., an inverse STFT, an inverse MDCT, or the like) to the frequency-domain representation of the dereverberated audio signal.

The time-domain representation of the dereverberated audio signal may be played or presented (e.g., by one or more speaker devices of a user device). In some implementations, the dereverberated audio signal may be stored, such as in local memory of the user device. In some implementations, the dereverberated audio signal may be transmitted, such as to another user device for presentation by the other user device, to a server for storage, or the like.

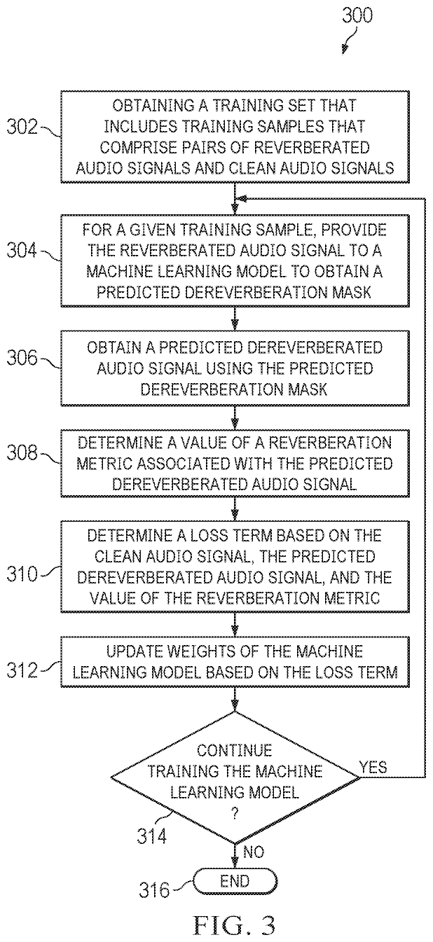

FIG. 3 shows a process 300 for training the machine learning model 210, so that the trained machine learning model 210 will be configured to generate a de-reverberated audio signal given an input audio signal.

First, in step 302 a training set is obtained. The training set includes training samples, where each training sample includes a clean audio signal (e.g., with no reverberation), and a corresponding reverberated audio signal. The clean audio signals may be considered “ground-truth” signals that the machine learning model is to be trained to predict or generate. The set may include any number of samples, e.g., 100 training samples, 1000 training samples, 10,000 training samples, or the like. As mentioned in the background section, a training sample may be obtained by generating pairs of a clean audio signal and a corresponding reverberated audio signal generated by convolving an acoustic impulse response (AIR) with the clean audio signal.

At step 304, for a given training sample, process 300 provides the reverberated audio signal to a machine learning model to obtain a predicted dereverberation mask. In some implementations, the machine learning model may be provided with a frequency-domain representation of the reverberated audio signal. The frequency-domain representation of the reverberated audio signal may be filtered or otherwise transformed using a filter that approximates filtering of the human cochlea.

At step 306, process 300 obtains a predicted dereverberated audio signal using the predicted dereverberation mask. For example, process 300 may apply the predicted dereverberation mask to the frequency-domain representation of the reverberated audio signal to obtain a frequency-domain representation of the dereverberated audio signal. Continuing with this example, in some implementations, process 300 can then generate a time-domain representation of the dereverberated audio signal.

At step 308, process 300 determines a value of a reverberation metric associated with the predicted dereverberated audio signal. The reverberation metric may be a speech-to-reverberation modulation energy of one or more frames of the predicted dereverberated audio signal. At step 310, process 300 determines a loss term based on the clean audio signal, the predicted dereverberated audio signal, and the value of the reverberation metric. The loss term may be a combination of a difference between the clean audio signal and the predicted dereverberated audio signal and the value of the reverberation metric. In some implementations, the combination is a weighted sum, where the value of the reverberation metric is weighted by an importance of minimizing reverberation in outputs produced using the machine learning model.

At step 312, process 300 updates weights of the machine learning model based at least in part on the loss term. Process 300 may use gradient descent and/or any other suitable technique to calculate updated weight values associated with the machine learning model. The weights may be updated based on other factors, such as a learning rate, a dropout rate, etc. The weights may be associated with various nodes, layers, etc., of the machine learning model.

At step 314, process 300 determines whether the machine learning model needs more training. Step 314 may involve a determination that an error associated with the machine learning model has decreased below a predetermined error threshold, a determination that weights associated with the machine learning model are being changed from one iteration to a next by less than a predetermined change threshold, and/or the like.

If, at step 314, process 300 determines that the machine learning model 210 is not to be additionally trained (“no” at block 314), process 300 will end 316. Conversely, if, at step 314, process 300 determines that the machine learning model 210 is to be additionally trained (“yes” at block 314), process 300 will loop back to step 304 and repeat steps 304-314 with a different training sample.

In order to generate a larger set of training samples, available, real AIRs are used to generate a set of synthesized AIRs. It is noted that a real AIR can be a measured AIR that is measured in a room environment (e.g., using one or more microphones positioned in the room). Alternatively, a real AIR can be a modeled AIR, generated, for example, using a room acoustics model that incorporates room shape, materials in the room, a layout of the room, objects (e.g., furniture) within the room, and/or any combination thereof. By contrast, a synthesized AIR is an AIR that is generated based on a real AIR (e.g., by modifying components and/or characteristics of the real AIR), regardless of whether the real AIR is measured or modeled.

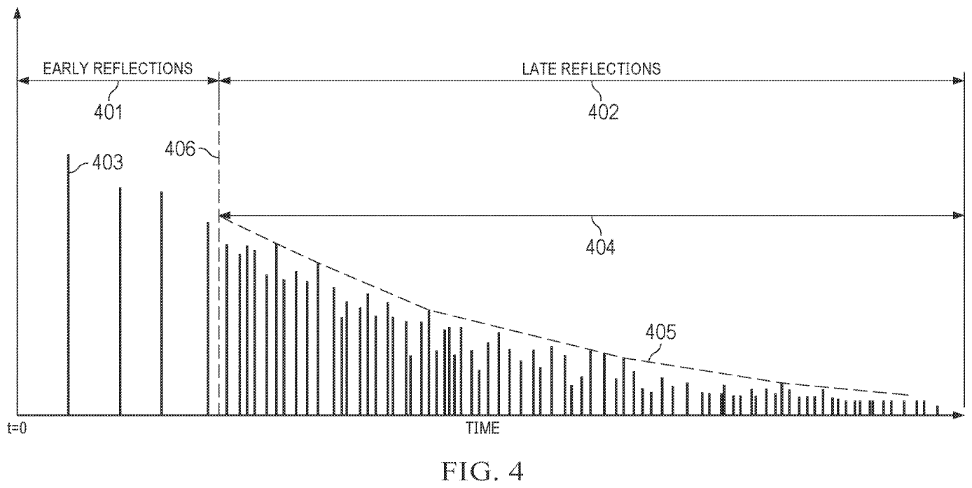

FIG. 4 shows an example of a measured AIR in a reverberant environment. In the diagram, time zero (t=0) represents the arrival of the direct sound. As illustrated, early reflections 401 arrive at a receiver concurrently or shortly after time zero. By contrast, late reflections 402 arrive at the receiver after early reflections 401. Early reflections include a plurality of spikes 403. Late reflections 402 are associated with a duration 404, which may be on the order of 100 milliseconds, 0.5 seconds, 1 second, 1.5 seconds, or the like. Late reflections 403 are also associated with a decay 405 that characterizes how an amplitude of late reflections 403 attenuates or decreases over time. The boundary 406 between early reflections and late reflections may be within a range of about 50 milliseconds and 80 milliseconds. Although the boundary 406 is here illustrated as a sharp boundary (one point in time) the boundary may be considered as a gradual transition.

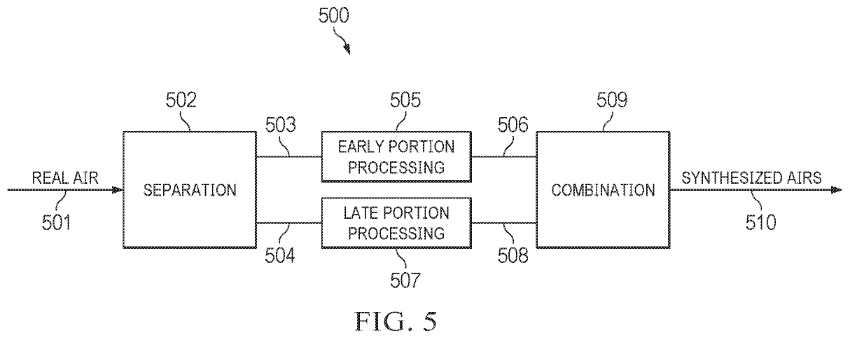

FIG. 5 shows a process for generating synthesized AIRs from a real AIR. In a first separation bock 501, the real AIR 502 is randomly separated into an early portion 503, AIRₑ(t), corresponding to early reflections of a direct sound, and a late portion 504, AIRₗ(t), corresponding to late reflection of a direct sound. The early portions 503 are processed (augmented) in an early portion processing block 505, to form a set of randomly modified early AIRs 506. The late portions 504 are processed (augmented) in a late portion processing block 507, to form a set of randomly modified late AIRs 508. The sets of modified early AIRs and late AIRs are then combined in combination block 509 to form a set of synthesized AIRs 510.

The block 502 here implements a pair of crossfade functions to provide a continuous transition between early AIR and late AIR. An early crossfade function ƒₑ(t) is defined as:

$${f}_{e} ( t ) = \{ \begin{matrix}1 & t < s \\ f ( t ) & s \leq t \leq s + d \\ 0 & t > s + d\end{matrix}$$

and a late crossfade function ƒₗ(t) is defined as:

$${f}_{l} ( t ) = 1 - {f}_{e} ( t ) ,$$

where ƒ(t) is a transition function of time which describes a continuous decrease from one to zero as t increases from s to s+d, where s is a randomly selected separation time point, s, and d is a randomly selected crossfade duration.

The separation time point s is typically between 5 and 100 ms, preferably between 20 and 80 ms. The crossfade duration d is typically between 1 and 10 ms.

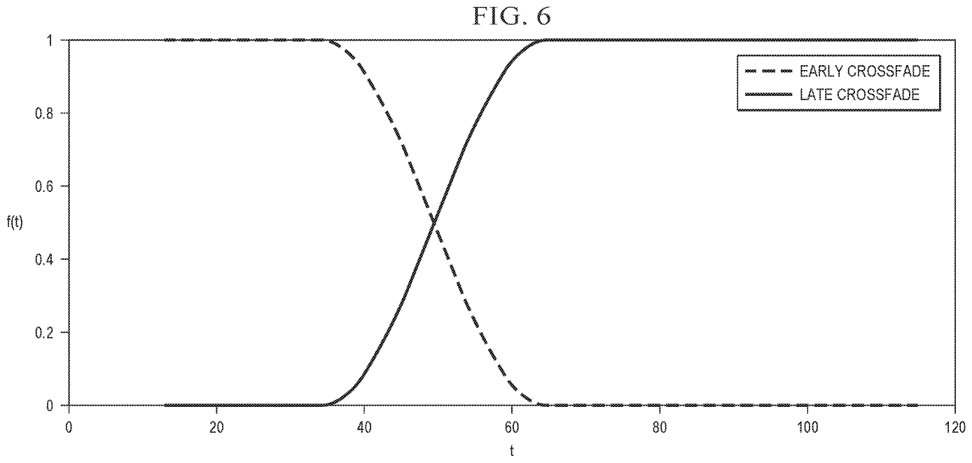

Various continuous transition functions ƒ(t) may be contemplated, including simple linear ramps and step-wise continuous functions. FIG. 6 shows an example of crossfade functions ƒₑ(t) and ƒₗ(t) where the transition function ƒ(t) has been chosen as

$$f ( t ) = {cos}^{2} ( \frac{π ( t - s )}{2 d} ) .$$

In FIG. 6, the x-axis is shown in samples. The sampling frequency in this example was 32 kHz, indicating the s is around 5 ms, and d is around 5 ms.

The early portion, AIRₑ(t), and the late portion, AIRₗ(t), may now be calculated as AIRₑ(t)=AIR(t)*ƒₑ(t) and AIRₗ(t)=AIR(t)*ƒₗ(t), respectively, where AIR(t) is the real AIR.

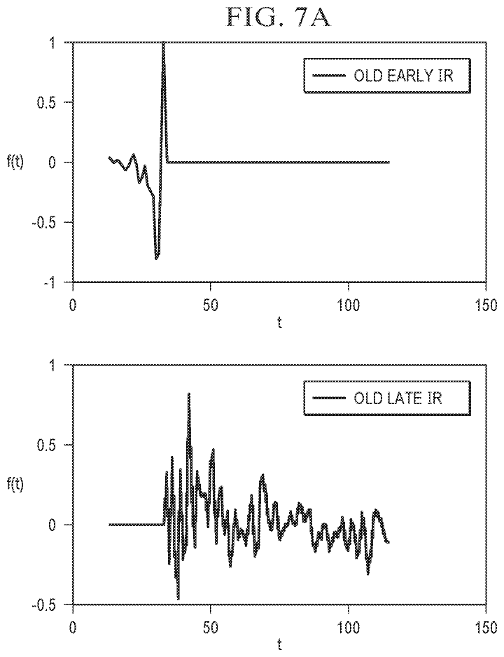

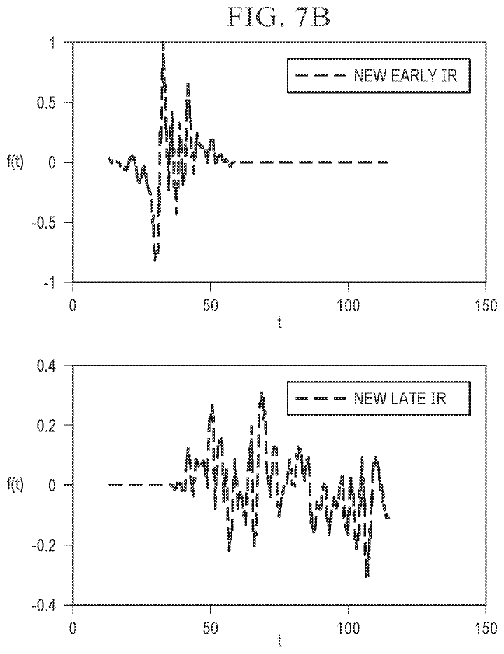

FIG. 7A shows how early and late portions of a real AIR are formed based on a sharp cut-off, while FIG. 7B shows how the early and late portions of the same real AIR are formed using the approach discussed above. In FIGS. 7A and 7B the x-axis is shown in samples. The sampling frequency was 32 kHz.

The augmentation of the early portions in block 505 may be performed in a conventional manner, e.g. involving a random rearrangement of the spikes 403 in time.

The augmentation of the late portions in block 507 may be a simple truncation, as proposed in the prior art, or it may involve a randomized attenuation (decay) function. The decay function may be an exponential decay, a linear function, a portion of a polynomial function, or the like.

In one implementation, the decay function is an exponential decay function:

$$g ( t ) = {e}^{\frac{t}{a}} ,$$

where a is a random decay parameter, 0<a<1.

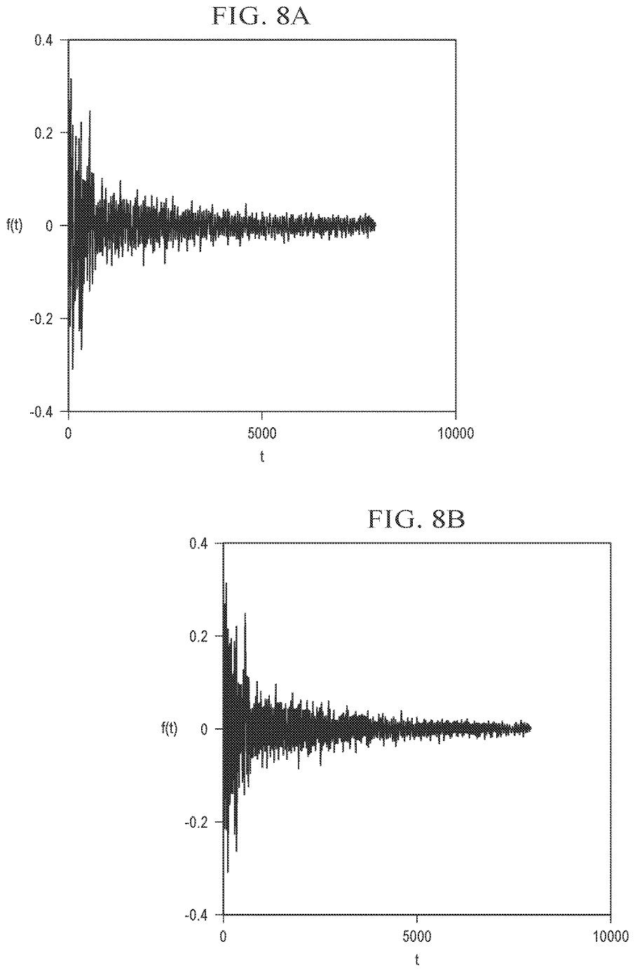

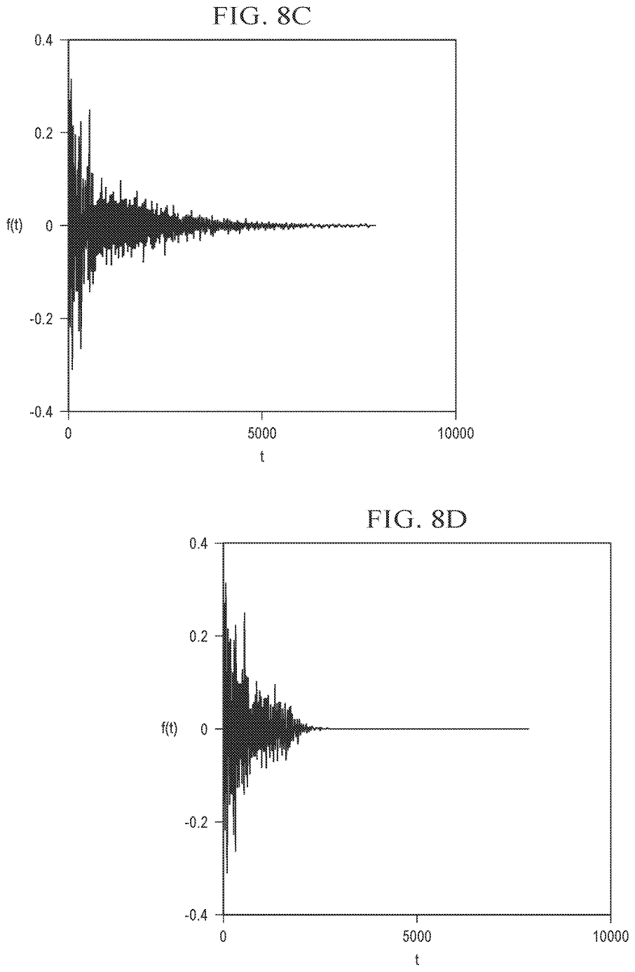

FIG. 8A shows an example of an original late AIR portion, obtained by the process in FIG. 4. FIGS. 8B-D show the late AIR portion in FIG. 8A, subject to the exponential decay function expressed above. In FIG. 8B, the decay parameter is 0.5. In FIG. 8C, the decay parameter is 0.1. In FIG. 8D, the decay parameter is 0.01. The sampling frequency in these examples was 32 kHz.

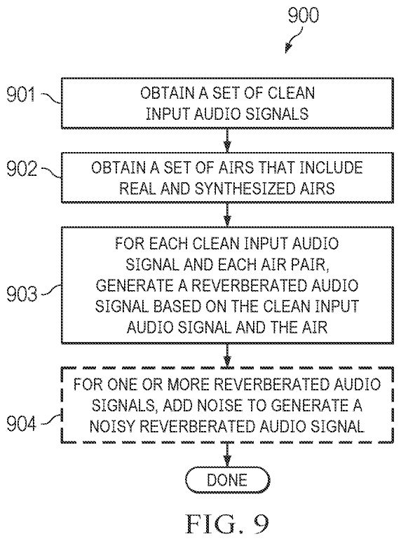

FIG. 9 shows an example of a process 800 for generating an augmented training set using real and/or synthesized AIRs. The augmented training set may be used for training a machine learning model for dereverberation of audio signals. Process 900 begins at 901 by obtaining a set of clean input audio signals (e.g., input audio signals without any reverberation and/or noise). The clean input audio signals in the set of clean input audio signals may have been recorded by one or several recording devices, in one or several different room environments. Each clean input audio signal may include any combination of types of audible sounds, such as speech, music, sound effects, or the like. However, each clean input audio signal is preferably devoid of reverberation, echo, and/or noise.

At block 902, process 900 obtains a set of AIRs that include at least one real (measured or modeled) AIR and/or a plurality of synthesized AIRs, obtained through the process in FIG. 4. The set of AIRs may include any suitable number of AIRs (e.g., 100 AIRs, 200 AIRs, 500 AIRs, or the like). The set of AIRs may include any suitable ratio of real AIRs to synthesized AIRs, such as 90% synthesized AIRs and 10% real AIRs, 80% synthesized AIRs and 20% real AIRs, or the like.

At block 903, process 900 can, for each pairwise combination of clean input audio signal in the set of clean input audio signals and AIR in the set of AIRs, generate a reverberated audio signal based on the clean input audio signal and the AIR. For example, in some implementations, process 900 can convolve the AIR with the clean input audio signal to generate the reverberated audio signal. In principle, given N clean input audio signals and M AIRs, process 900 can generate N×M reverberated audio signals.

At block 904, process 900 adds noise to one or more of the reverberated audio signals to generate a noisy reverberated audio signal. Examples of noise that may be added include white noise, pink noise, brown noise, multi-talker speech babble, or the like. Process 900 may add different types of noise to different reverberated audio signals. For example, in some implementations, process 900 may add white noise to a first reverberated audio signal to generate a first noisy reverberated audio signal. Continuing with this example, in some implementations, process 900 may add multi-talker speech babble type noise to the first reverberated audio signal to generate a second noisy reverberated audio signal. Continuing still further with this example, in some implementations, process 900 may add brown noise to a second reverberated audio signal to generate a third noisy reverberated audio signal. In other words, in some implementations, different versions of a noisy reverberated audio signal may be generated by adding different types of noise to a reverberated audio signal. It should be noted that, in some implementations, block 900 may be omitted, and the training set may be generated without adding noise to any reverberated audio signals.

At the end of block 904, process 900 has generated a training set comprising multiple training samples. Each training sample includes the clean audio signal and a corresponding reverberated audio signal, with or without added noise. It is important to note that one single clean audio signal may be used to generate multiple reverberated audio signals by convolving the clean audio signal with multiple different AIRs. And similarly, one single reverberated audio signal (e.g., generated by convolving a single clean audio signal with a single AIR) may be used to generated multiple noisy reverberated audio signals, each corresponding to a different type of noise added to the single reverberated audio signal. Accordingly, a single clean audio signal may be associated with 20, 30, 100, or the like training samples, each comprising a different corresponding reverberated audio signal (or noisy reverberated audio signal).

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the preferred embodiments described above. On the contrary, many modifications and variations are possible within the scope of the appended claims. For example, other approaches to synthesizing early and late portions of the synthesized AIR may be contemplated.

1. A method for training a machine learning model, the method comprising:
generating a set of synthesized AIRs from a real acoustic impulse response, AIR(t);
using the set of synthesized AIRs to generate a plurality of training samples, each training sample comprising a non-reverberated audio signal and a reverberated audio signal formed by applying one of the synthesized AIRs to the non-reverberated audio signal; and
training the machine learning model with the plurality of training samples, such that the machine learning model, after training, is configured to generate a de-reverberated audio signal given an input audio signal;
wherein the set of synthesized AIRs is generated by:
forming an early portion, AIRₑ(t), of the real AIR corresponding to early reflections of a direct sound, and a late portion, AIRₗ(t), of the real AIR corresponding to late reflections of a direct sound, and
generating each synthesized AIR by modifying at least one of the early portion and the late portion and recombining the possibly modified early portion and possibly modified late portion;
wherein the early portion and the late portion are formed by:
selecting a random separation time point, s,
selecting a random crossfade duration, d,
defining a transition function of time ƒ(t) which describes a continuous decrease from one to zero as t increases from s to s+d,
defining an early crossfade function as:
$${f}_{e} ( t ) = \{ \begin{matrix}1 & t < s \\ f ( t ) & s \leq t \leq s + d \\ 0 & t > s + d\end{matrix}$$
defining a late crossfade function as:
$${f}_{l} ( t ) = 1 - {f}_{e} ( t ) ,$$
and
calculating the early portion, AIRₑ(t), and the late portion, AIRₗ(t), as:
$${AIR}_{e} ( t ) = AIR ( t ) * {f}_{e} ( t ) and {AIR}_{l} ( t ) = AIR ( t ) * {f}_{l} ( t ) , respectively .$$

2. The method according to claim 1, wherein the transition function ƒ(t) is defined as:
$$f ( t ) = {cos}^{2} ( \frac{π ( t - s )}{2 d} ) .$$

3. The method according to claim 1, wherein the separation time point s is between 5 and 100 ms.

4. The method according to claim 1, wherein the crossfade duration d is between 1 and 10 ms.

5. The method according to claim 1, wherein modifying the late portion involves applying a randomized attenuation function, g(t), to the late portion.

6. The method according to claim 5, wherein the randomized attenuation function is an exponential decay function:
$$g ( t ) = {e}^{\frac{t}{a}} ,$$
where a is a random decay parameter.

7. The method according to claim 6, wherein 0<a<1.

8. A method for de-reverberating an input audio signal, comprising:
providing the input audio signal to a machine learning model trained according to the method in claim 1, and
generating, using the machine learning model, a de-reverberated output audio signal.

9. A computer implemented system for training a machine learning model, the system comprising:
a computer implemented process (500) for generating a set of synthesized AIRs from a real acoustic impulse response, AIR(t);
a computer implemented process (900) for generating a plurality of training samples, each training sample comprising a non-reverberated audio signal and a reverberated audio signal formed by applying one of the synthesized AIRs to the non-reverberated audio signal; and
a computer implemented training process (300) for training the machine learning model using a training set including a plurality of training samples, each training sample comprising a non-reverberated signal and a reverberated signal formed by applying one of the synthesized AIRs to the non-reverberated audio signal;
wherein the computer implemented process for generating a set of synthesized AIRs includes:
a separation block configured to receive a real acoustic impulse response, AIR(t), and to form an early portion, AIRₑ(t), of the real AIR corresponding to early reflections of a direct sound, and a late portion, AIRₗ(t), of the real AIR corresponding to late reflections of a direct sound;
at least one processing block for modifying at least one of the early portion and the late portion;
a combination block for recombining the possibly modified early portion and the possibly modified late portion to form a synthesized AIR;
wherein the separation block is configured to:
select a random separation time point, s,
select a random crossfade duration, d,
define a transition function of time ƒ(t) which describes a continuous decrease from one to zero as t increases from s to s+d,
define an early crossfade function as:
$${f}_{e} ( t ) = \{ \begin{matrix}1 & t < s \\ f ( t ) & s \leq t \leq s + d \\ 0 & t > s + d\end{matrix}$$
define a late crossfade function as:
$${f}_{l} ( t ) = 1 - {f}_{e} ( t ) ,$$
and
calculate the early portion, AIRₑ(t), and the late portion, AIRₗ(t), as:
$${AIR}_{e} ( t ) = AIR ( t ) * {f}_{e} ( t ) and {AIR}_{l} ( t ) = AIR ( t ) * {f}_{l} ( t ) , respectively .$$

10. The system according to claim 9, wherein the transition function ƒ(t) is defined as:
$$f ( t ) = {cos}^{2} ( \frac{π ( t - s )}{2 d} ) .$$

11. The system according to claim 9, wherein the separation time point s is between 5 and 100 ms.

12. The system according to claim 9, wherein the crossfade duration d is between 1 and 10 ms.

13. The system according to claim 9, wherein one of the processing block(s) is configured to modify the late portion by applying a randomized attenuation function, g(t), to the late portion.

14. The system according to claim 13, wherein the randomized attenuation function is an exponential decay function:
$$g ( t ) = {e}^{\frac{t}{a}} ,$$
where a is a random decay parameter.

15. The system according to claim 14, wherein 0<a<1.

16. A computer program product comprising computer program code portions configured to perform the method according to claim 1 when executed on a computer processor.
